(19) United States
(12) Patent Application Publication
(10) Pub. No.: US 2004/0243710 A1
(43) Pub. Date: Dec. 2, 2004

(54) Method of user data exchange in the data network and a data network

(76) Inventor: Xiaolei Mao, Shenzen (CN)

Correspondence Address: McDermott Will & Emery, 600 13th Street N W, Washington, DC, 20005-3096, US

(21) Appl. No.: 10/485,638

(22) PCT Filed: Jun. 6, 2002
(86) PCT No.: PCT/CN02/00396

(30) Foreign Application Priority Data
Aug. 3, 2001 (CN) 01124676.6

(51) Int. Cl. G06F 15/16

(52) U.S. Cl. 709/227

(57) ABSTRACT

A data network system implemented through adding IPN servers and HTTPex servers on the traditional data network system; said data network system designates a home IPN server for each network user, and each IPN server is mapped to one or more attributing HTTPex servers. The servers are designed to achieve logon and HTTPex service ID application task for network users; a plurality of IPN servers may be deployed in the network, and the number of them depends on the number of users and the processing capacity of each IPN server. The HTTPex servers are designed to exchange data between the users and transfer billing information to relevant billing devices. A method for data exchange in above system comprises the following steps: each user is registered to an IPN, the user logs on the IPN server, and the application data packets are exchanged between the user and other users through the HTTPex servers. Owing that the present invention utilizes common IPN servers and HTTPex servers to achieve data exchange between users, direct communication between upper layer applications of users can be accomplished, not confined by user types, such as intranet users or community network users.

### FIELD OF THE INVENTION

The present invention relates to data communication technology field, particularly to a method for exchanging data between private network users and between private network users and traditional public network users and a data network system implementing the method.

### BACKGROUND OF THE INVENTION

The object of any communication system is to transfer information as much as possible via one cable. The key functions of a communication system include: converge all communication sources and carry out transmission for them; separate information at the destinations to deliver the information to individual receivers. The ultimate purpose of the communication system is to support communication to anyone anywhere at any time.

During the telephone network period before data networks appear, communication usually is deemed as communication between individuals. As data networks appear, communication becomes the affair between individuals and computers. In typical data network applications, such as webpage browsing, information search, and E-mail transceiving, communication happens between individuals and servers.

As broadband access networks and broadband backbone networks emerge, data networks evolve greatly. With high-performance routers and core routers, the bandwidth of a single interface can be as high as 2.5 Gbps or 10 Gbps. The network structure is simplified, and messages between users are transferred via fewer nodes than before. When the bandwidth of the backbone network reaches or exceeds the total bandwidth used by all users, it is considered as enough bandwidth of data network. In this case, users can be well connected to each other physically, and interactive applications between users can be realized successfully. If the users are connected to the public network and have fixed IP addresses, free interactive communication between users can be achieved. However, it is impractical to provide a fixed IP address to each user due to limited IP address resource; furthermore, there are numerous private networks such as intranet, network cafe, and community network, and the users in the networks use proxy servers instead of fixed IP addresses; therefore, interactive application between the users have to achieved via additional servers.

An intranet is a typical private network, which utilizes private network address segments and NAT technology to connect private TCP/IP networks via public data networks. FIG. 1 shows the schematic diagram of access to the public network from an intranet. As shown in FIG. 1, an intranet comprises users, a DNS server, a DHCP server, and a private network; the users and servers are allocated with private network IP addresses and they have to access the public network via a proxy server and a router. Wherein, access to Web servers in the public network requires a proxy server; access to E-mail servers in the public network requires a router.

Private network addresses refer to internal network addresses of the hosts (intranet addresses or private network addresses); while public network addresses refer to external addresses of a LAN (unique IP addresses in Internet) in the public network. The IP Address Allocation Organization stipulate the following 3 network address segments as reserved for private networks:

10.0.0.0-10.255.255.255

172.16.0.0-172.31.255.255

192.168.0.0-192.168.255.255

That is to say, above 3 network address segments will not be allocated in Internet; however, they may be used within LANs, and the internal network addresses of different LANs may be identical. In case a company chooses other network address segments beyond above segments for internal network addresses, there may be confusion in the routing list.

Hosts in a private network should utilize NAT technology to access Internet or communicate with hosts outside the network. For instance, suppose the internal network address segment of a LAN starts from 10.0.0.0 and the exoteric IP address of the LAN is 203.196.3.23, when a host (internal address: 10.1.1.48) in the LAN tries to access a server (202.18.245.251) outside of the LAN in WWW mode, the host (10.1.1.48) will choose a source port (6084) and destination port (80) and send a message; when the message passes through the proxy server, the source address and source port of said message may be changed to 203.196.3.23: 32814, but the destination address and port will not be changed.

The proxy server maintains an Address-Port Mapping List (the address refers to internal private IP addresses and the port refers to source port numbers of outbound IP messages, the latter is also the destination port numbers of inbound IP messages). When the WWW server outside of the network returns the result, the proxy server will detect the destination port number 32814 in the IP message, convert the destination IP address and port in the returned message to 10.1.1.48: 6084, and then transfer the converted IP message to the internal network; in this way, the internal host (10.1.1.48) can access the external WWW server. Similarly, all users in the internal network can access external networks with the public network address of the proxy server.

In brief, NAT converts internal IP addresses and ports to external network IP addresses and ports and vice versa. That is:

(Private Network Address+Port)<−>(Public Network Address+Port)

The advantage of NAT is:

1. Enabling internal network hosts to access external resources;

2. Providing “Privacy” protection for internal hosts to enhance security;

3. Settling the issue of limited IP address resource.

However, with NAT, both the source port numbers of all outbound IP messages and the destination port numbers of all inbound IP messages are changed; therefore, internal hosts can only serve as clients instead of servers. A client can only initiate connection instead of accepting connection. With NAT, internal users may receive files from servers and transfer files to servers; however, these tasks can only be achieved via an external server. That is to say, a user has to connect to the server first; before the connection to the server is established, the server is unable to detect the user to achieve upper layer applications; for example, when users implement VOIP application in a private network, because NAT uses a dynamic IP address pool and the users in the private network share a public IP address but VOIP requires mapping user session to a fixed IP address. Therefore, NAT doesn't support simultaneous upper layer applications, such as VOIP and Netmeeting.

### SUMMARY OF THE INVENTION

An object of the present invention is to provide a new method of exchanging data between data network users, which can overcome above disadvantages to connect network users in private networks (e.g., intranet) and new networks (e.g., 3 G) to the public network, in order to achieve communication between private network users, or between private network users and public network users.

Another object of the present invention is to provide a data network system implementing said method of exchanging data; said system only requires adding an appropriate server on the traditional network and installing client software on the users' computers instead of modifying the traditional network.

To attain above objects, a method of exchanging data between data network users according to the present invention comprises: registering an IP number (IPN) and determining a home IPN server for each user; the IPNs of the users are stored in the corresponding home IPN servers. The connecting step between the users via IPNs and IPN servers comprises the following steps:

A. The caller logging on the home IPN server;

B. The caller searching for the called home IPN server according to its home IPN server and the called IPN;

C. The called home IPN server determining whether the called is online; if yes, it informing the called of the calling IPN and IP address of the calling home IPN server, otherwise ending the connection;

D. If the called doesn't give any response, the calling home IPN server returning a CONNECTION REJECTED message to the caller, otherwise going to the next step;

E. If the called gives a response to accept the call, the called home IPN server returning a CONNECTION GRANTED message to the caller; otherwise the called home IPN server returning a RECEPTION REJECTED message to the caller and ending the connection;

F. After the called confirms to connect, the caller and the called applying for HTTPex (Hypertext Transfer Protocol and its Extensive part) service IDs and the HTTPex servers for the current call connection from the calling home IPN server simultaneously;

G. The calling home IPN server sending the determined calling HTTPex service ID and called HTTPex service ID to the caller and the called respectively; at the same time, it also sending the caller ID and the called ID to determined HTTPex servers;

H. The caller and the called establishing connections to the HTTPex servers respectively and carrying out data exchange via the HTTPex servers;

I. Disconnecting the connections to the HTTPex servers to end the current call connection.

In above method of exchanging data between data network users, the caller and the called establishing connections to the HTTPex servers to carry out data exchange according to step H comprises exchanging upper layer data packets; the step of transmission of the upper layer data packet from the current user to the opposite user comprises the following steps:

1) The caller or the called encapsulating the upper layer data packet and then sending them to the HTTPex server;

2) The HTTPex server transferring the data packet from the current receiving mailbox to the opposite sending mailbox;

3) When finding the data packet in the opposite sending mailbox, the HTTPex server replacing the IP address and port in the data packet;

4) When receiving a “POP” command from the opposite user, the HTTPex server sending the modified data packet to the opposite user;

5) The opposite user parsing the data packet and forwarding them to the upper layer application.

Wherein the caller and the called encapsulating the upper layer data packet and then sending them to the HTTPex server according to step 1) further comprises the following steps:

a. The upper layer application of the caller or the called connecting the opposite virtual IP (VIP);

b. HTTPex client side of the user intercepting the upper layer application data packet and processing them as follows:

(i) Replacing the opposite VIP destination address with the IP address of the HTTPex server while neglecting to replacing for data packet to other addresses;

(ii) The destination port of the upper layer application serving as the Destination Port Segment (DPS) in the data packet;

(iii) The source port of the upper layer application serving as the Source Port Segment (SPS) in the data packet;

(iv) Replacing the destination port of the data packet with the current access port or the proxy server's access port;

(v) Replacing the source port of the data packet with the HTTPex-connected source port;

c. Adding a PUSH command to the processed data packet, encapsulating the data packet, and then sending the encapsulated data packet to the HTTPex server via the proxy server or the gateway.

Wherein the HTTPex server replacing the IP address and port in the data packet when finding the data packet in the opposite sending mailbox according to step 3) further comprises the following steps:

(i) Replacing the destination IP address of the data packet (i.e., IP address of the HTTPex server) with the source IP address for access of the current user (i.e., the IP address for accessing the HTTPex server);

(ii) Replacing the destination port of the data packet with the source port of the opposite user;

(iii) Replacing the source port of the data packet with the HTTP port;

Wherein the opposite user parsing the data packet into messages of upper layer application according to step 5) further comprises the following steps:

(i) extracting the DPS in the data packet and replacing it with the destination port of the data packet;

(ii) extracting the SPS in the data packet and replacing it with the source port of the data packet;

(iii) Replacing the source IP address in the data packet with the VIP address set by the upper layer application.

To attain another object of the present invention, a data network service system of the present invention comprises:

User terminals;

Background system, which is designed to monitor network operation conditions, preset user accounts manually or automatically, modify user properties manually, and perform troubleshooting in case of network failure;

Authentication database, which is designed to store various user identity information;

A connection network, which is used to connect said devices and support communication between them; said system also comprises:

IPN servers, which are designed to achieve user's logon and user's HTTPex service ID application;

HTTPex servers, which are designed to support data exchange between users.

Said data network service system also comprises a registration server to perform registration for new users.

Said data network service system also comprises a billing module, which is designed to perform real-time billing for users.

Said data network service system also comprises an application layer gateway, which is designed to connect to private networks for users through HTTPex access, so as to provide various network services for users.

The present invention is described in detail in accordance with the following embodiments and the drawings.

### BRIEF DESCRIPTION OF THE DRAWINGS

FIG. 1 is the schematic diagram of access to the public network from an intranet;

FIG. 2 shows the structure of the data network system according to the present invention;

FIG. 3 is a flow chart of connection establishment and data exchange between users according to the present invention;

FIG. 4 is a flow chart of data packet exchange between users' upper layer applications via HTTPex servers.

### DETAILED DESCRIPTION OF THE EMBODIMENTS

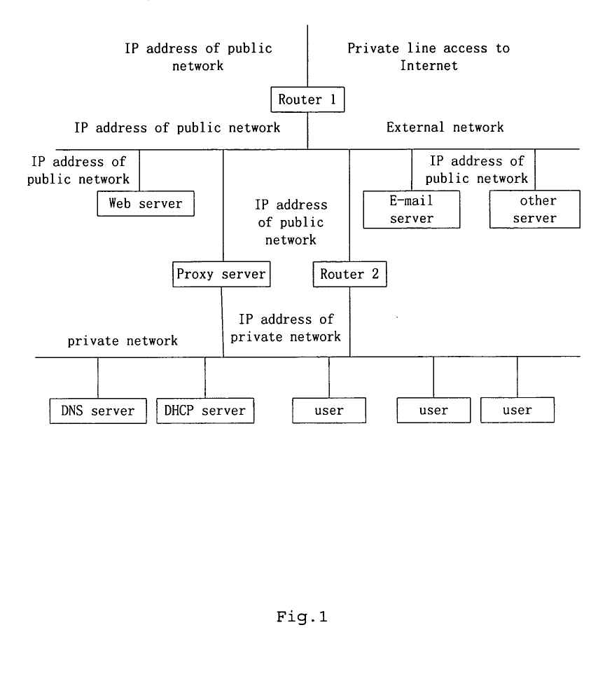

FIG. 1 is described above and will not be described hereinafter.

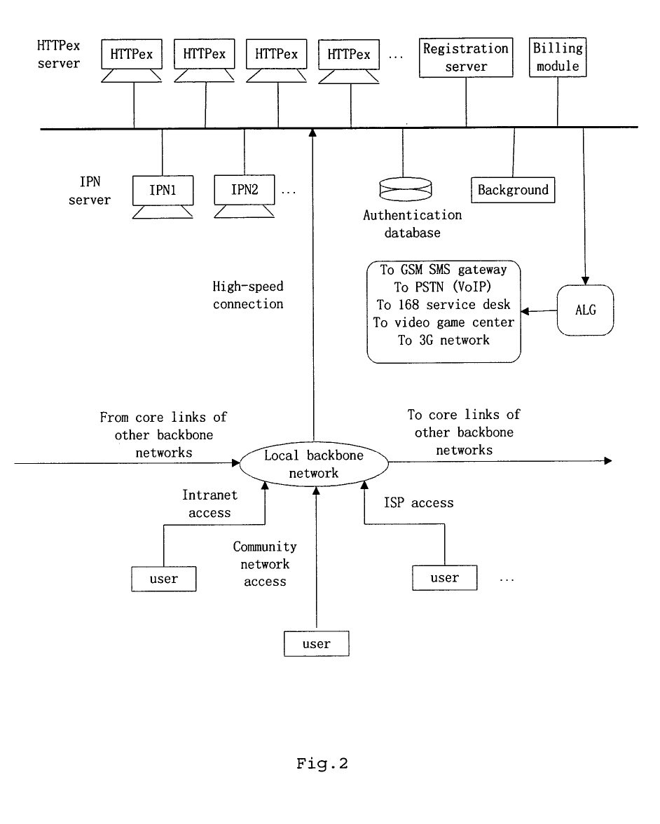

As shown in FIG. 2, the data network system in the present invention comprises at least user terminals, a connection network, a background system, an authentication database, IPN servers and HTTPex servers. In the present invention, a user terminal is a common network access terminal, terminal in an intranet, terminal in a network cafe or a 3 G intelligent terminal, etc.; HTTPex is a new protocol put forth in the present invention for communication between upper layer applications on any two user terminals, please see the following description for the content of the HTTPex protocol; the background system is designed to monitor network operation conditions, preset user accounts manually or automatically, modify user attribute manually, and performs troubleshooting in case of network failure; the authentication database is designed to store various user identity information, including user account number, password, and billing amount; the connection network is used to connect above devices and communicate between the devices, including access network, local backbone network, Internet, and PTSN networks that connect various servers and user terminals; In the present invention, the background system, authentication database, and connection network are known technologies, and any common technician in the field can implement them. Therefore, they are not described further. The IPN servers are used to perform user logon and user HTTPex service ID application; the users can utilize the IPN servers to store deposit in their IPN accounts through purchasing value storage cards and log on the home IPN servers to entry user IPN and the card numbers. There maybe a plurality of IPN servers, and the specific number may be determined according to the number of users and the processing capacity of the IPN servers; moreover, load equalization among the IPN servers may be implemented. The HTTPex servers are used to exchange data between the users, and they can transfer billing information to corresponding billing devices; each HTTPex server is attributed to a specific IPN server, and each IPN server may has a plurality of HTTPex servers. The mapping relation between the HTTPex servers and the IPN servers is determined according to the traffic volume.

Said data network system in the embodiment shown in FIG. 2 also comprises a registration server, a billing module, and an application layer gateway. Wherein the registration server is designed to register new users and it is a toll-free WEB site; any user can access it. The registration server is connected to a database. Whenever a new user is registered, the database is updated accordingly. The registration process is achieved with a CGI program in the registration server. If the user registers use the system with a smart card (with a preset account number), registration on the registration server is unnecessary because the preset account number is already in the authentication database and with certain deposit. The billing module is used to perform real-time billing for users. During the billing process, the user attribute information in the database will also be modified. The application layer gateway is used to connect common users accessing the network through HTTPex servers to specific applications in various networks, such as GSM short message gateway, PSTN network, 168 service desk, video game center, and 3 G network, etc., as shown in FIG. 2. Any terminal with HTTPex application installed in it can use any network service provided by the data network system after identity authentication, including accessing different applications in the same network and accessing different networks. However, no matter what the network service is, the billing will be carried out accordingly. Furthermore, charging is accomplished along with billing, i.e., the correct amount will be deducted from the user's account.

To describe more easily, the portion except for the backbone network, user access, and network service in the data network system of the present invention is collectively referred as IPN system. The third layer switch in the Ethernet is represented with a thick line in FIG. 2 in view that the switch connects all components in the network just like a line. The bandwidth of that line is equivalent to the switching capacity of the switch.

From the viewpoint of traditional telecom concept, the community network and the intranet in the data network system of the present invention are equivalent to end offices and PABXs, and the local backbone network provides trunk transmission capacity; the role of the IPN system in the present invention is similar to a trunk switching office or an interface office between the backbone networks and it achieves switching for service. From the viewpoint of functionality, the IPN server is similar to an IN device in tradition telecom concept, and the HTTPex server is similar to a GMSC (Gateway Mobile Switching Center) switching device.

Said data network system is implemented as follows: adding HTTPex servers and IPN servers in traditional network and determining a home IPN server for each use, the users can log on the network via the IPN servers and communicate via the HTTPex servers; therefore, direction communication between upper layer applications may be implemented, no confined by private networks, such as intranet or community network.

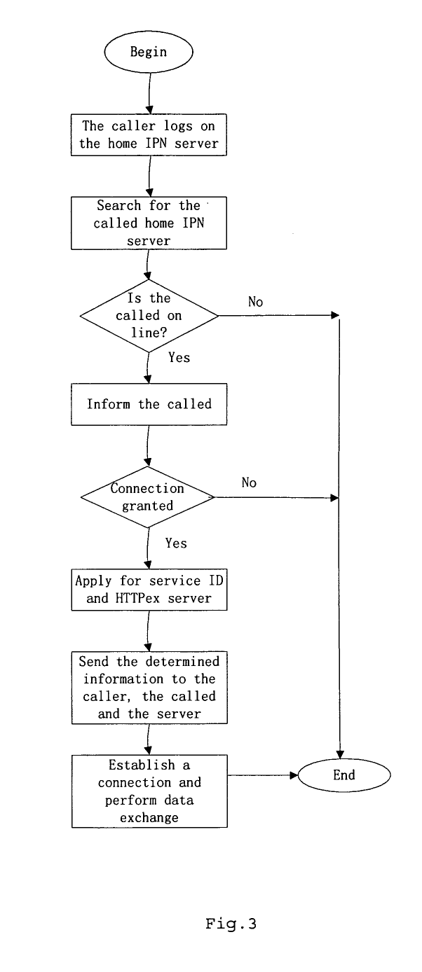

To achieve data exchange between users through the data network system of the present invention, the system registers an IPN and designates a home IPN server for each user; the user's IPN is stored in the home IPN server. Then, the system achieves data exchange through the following steps, as shown in FIG. 3, wherein each block in FIG. 3 corresponds to a step, such as A, B, . . . , I:

Step A: The caller logs on the home IPN server via its terminal. The logon process may be achieved with the calling IPN and password or E-mail address and password. The process is:

1) The caller enters his/her IPN and password or E-mail address and password on the terminal;

2) The user's home IPN server authenticates the IPN and password or E-mail address and password;

3) After successful authentication, the connection between the caller's terminal and the home IPN server is kept.

Step B: The caller logs on his/her home IPN server, and then searches for the called home IPN server through his/her home IPN server and the IPN of the called; the searching process usually is: the caller enters the IPN of the called on its terminal, the calling home IPN server parses the IPN of the called and obtain the IP address of the called home IPN server from the database, then, the calling home IPN server informs the called home IPN server according to the IP address to establish a communication link between them.

In case the caller tries to establish the connection through entering the E-mail address of the opposite user instead of entering the called IPN directly, during the calling home IPN server searches for the called home IPN server, the caller have to enter the called E-mail address; then the calling home IPN server searches for the called IPN according to the E-mail address in the database and then search for the called home IPN server according to the called IPN.

Step C: the user has to log on his/her home IPN server first, so the home IPN server knows the user's access activity; therefore, the called home IPN server should determine whether the called is online; if the called is not online, the connection can't be established; therefore, all connection steps should be endd; if the called is online, the calling IPN and the IP address of the calling home IPN server should be sent to the called.

Step D: in case the called doesn't respond to the caller even though he/she is online, the called home IPN server will return a rejection message via the calling home IPN server after a certain time period; in case the called responds, the connection steps may be continued.

Step E: Even though the called responds, it is possible that the connection will not be established. Usually there are two cases: one is granting connection, the other is rejecting connection. If the called confirms to accept the call, the called home IPN server will return a CONNECTION GRANTED message to the calling home IPN server; if the called refuse to connect, the called home IPN server will return a CONNECTION REJECTED message to the calling home IPN server and ends the connection;

Step F: The object of adding HTTPex servers according to the present invention is to achieve data exchange through them. Therefore, when the called grants to connect, an HTTPex server for data exchange between the caller and the called shall be determined by the calling home IPN server, which may have one or more HTTPex servers. The HTTPex server for data exchange will be designated from the subordinate HTTPex servers of the calling IPN server. Therefore, the caller and the called apply for the HTTPex service ID and the HTTPex server for the current call connection simultaneously.

Step G: The calling home IPN server send the calling HTTPex server ID and called HTTPex server ID to the caller and the called respectively; at the same time, it also sends calling user ID and called ID to the HTTPex servers.

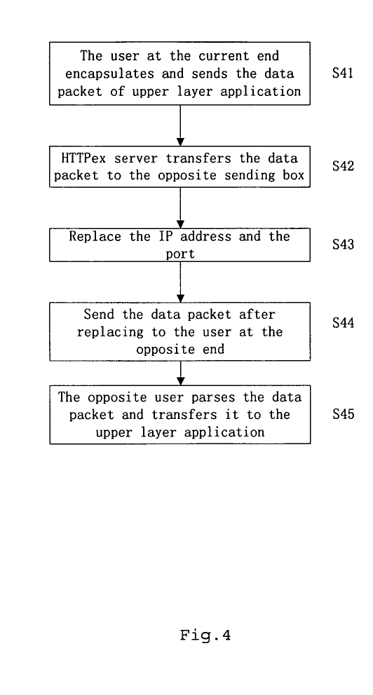

Step H: The caller and the called establish connections to the HTTPex servers respectively and carry out data exchange via the HTTPex servers. The data exchange includes exchange of upper layer data packets. The process through which an upper layer data packet is transferred from the user at the current end (the caller or the called) to the opposite end (the called or the caller) usually comprises the following step, as shown in FIG. 4:

First, please see step S41 in FIG. 4, wherein the caller/called encapsulates the upper layer data packet and then sends the encapsulated data packet to the HTTPex server determined in above step F; the process is: the upper layer application at the current end connects the VIP at the opposite end, just like connecting a user in the public network; however, the VIP address shall be preset at the user terminal.

Then, please see step S42 in FIG. 4, wherein the HTTPex client at the current end intercepts the data packet of the upper layer application and processes it as follows: (i) Replace the opposite VIP destination address with the IP address of the HTTPex server while neglecting to replacing for data packet to other addresses; (ii) The destination port of the upper layer application serves as DPS in the data packet; (iii) The source port of the upper layer application serves as SPS in the data packet; (iv) Replace the destination port of the data packet with the current access port or the proxy server's access port; (v) Replace the source port of the data packet with the HTTPex-connected source port; After above processing, it adds a PUSH command to the data packet and encapsulates the data packet, and then it sends the data packet to the HTTPex server via the proxy server or the gateway. Above source port is allocated automatically by the operating system when the TCP connection is established, and each connection has its own source port, which, once is used, indicates the connection is established. There is surely a “destination port” in a TCP message; whereas “Destination Port Segment (DPS)” is a unique feature of HTTPex protocol, which is above TCP protocol; therefore, the position of DPS is in the body part of a TCP message, whereas “destination port” is in the header part of the TCP message. Above PUSH command is designed to request the HTTPex server to receive the information from the user, including the HTTPex service ID and user ID.

Next, please see step S43 in FIG. 4, the HTTPex server transfers the received data packet from the current receiving mailbox to the opposite sending mailbox; when the HTTPex server detects a data packet in the opposite sending mailbox through its CPU in polling mode, it replace the IP address and port of the data packet. In addition, a mailbox bell may be set at the HTTPex server to detect whether there is a data packet in the opposite sending mailbox; when a data packet arrives, said mailbox bell will inform the CPU automatically. The data packet is sent by the opposite user to the HTTPex server, so the destination IP address and destination port of the data packet are IP address and port of the HTTPex server respectively, and the source port of the data packet is the port of the current end; therefore, they should be replaced as follows: i) the destination address of the data packet is replaced with the source IP address of the current user (i.e., the IP address used by the user to access the HTTPex server); ii) the destination port of the data packet is replaced with the source port of the opposite user; iii) the source port of the data packet is replace with the HTTP port (80) of the HTTPex server.

See step S44 in FIG. 4, wherein when receiving a “POP” command from the opposite user, the HTTPex server sends the modified data packet to the opposite user;

At last, please see step S45 in FIG. 4, wherein the opposite user parses the received data packet into a message of the upper layer application and sends it to the upper layer application; thus the entire process of sending a data packet from the current upper layer application to the opposite upper layer application is achieved. The parsing step comprises: (1) extract the DPS in the data packet and replace it with the destination port of the data packet; (2) extract the SPS in the data packet and replace it with the source port of the data packet; (3) replace the source IP address of the data packet with the VIP address set by the upper layer application.

Step I: The connections to the HTTPex servers are disconnected to end the call connection. During the data exchange between the caller and the called, the connection is kept; once either part hangs up or doesn't respond for a certain time period, the HTTPex server will disconnect the connection and end the data exchange for the current session.

The data network system and the process of network user connection and data exchange according to the present invention are described completely above. To utilize above data network system to achieve data exchange between HTTPex users, 3 new protocols are defined in the present invention:

1. ISP (IPN Server's Protocol);

2. HTTPex;

3. HSP (HTTPex Server's Protocol)

Every user requires an IPN to perform access and data exchange through above IPN data network system, so hereunder we will describe the IPN in brief before we introduce above 3 protocols:

A user has to apply for an IPN before using the IPN system. An IPN is an account number, certain deposit included. Before using the services provided by the IPN system, the user has to be authenticated through IPN. After successful identity authentication, the user can establish a connection for the required service. After the connection is established, the user will obtain a HTTPex service ID. With that ID, the user can establish a physical connection for the service, and real-time billing and charging will be performed through a billing module.

IPN coding is a sophisticated coding method that borrows idea from PSTN coding rule. To meet present and future demands, a complete IPN can be a 20-byte string, including:

Country Code: 3 bytes, for example, 086 for China, 001 for USA, 007 for Russia, 852 for Hong Kong district;

Area Code: 3 bytes, for example, 010 for Beijing, 021 for Shanghai, 755 for Shenzhen;

Home Code: 4 bytes, 0-9999, the code of the home IPN server, determined by the service provider. The code segment is similar to the office number in a phone number.

User ID: 10 bytes, user-defined. Arabic numerals are recommended. In case it is shorter than 10 bytes, the rest bytes will be filled with space; in this way, the user ID may be entered through a keypad (similar to the keypad of a common telephone).

The user registers the user ID on a specified server. In addition, E-mail address and other simple information may also be registered along with the user ID, and a simple Web page may be submitted. After registration, the user will obtain the home code and logon password from the server. The user may modify the password freely; however, the home code can't be modified. Because the E-mail address and other information are registered, besides the IPN, the user may also use the E-mail address or other information during user logon or connection to another user.

After successful registration, the user should place deposit in his/her IPN account within a certain time period; otherwise the registration information will be deleted automatically by the database system. The user may also place deposit in the IPN account through purchasing a value storage card, and the operation is similar to that in a Wireless Intelligent Network (IN).

The IPN data network system supports fixed terminals just like telephone booths. A fixed terminal has a fixed IPN, which is used to log on the IPN server automatically. When the called selects reverse-charge mode, the terminal may serve as the caller; when the called selects normal charging, the fixed IPN only accepts incoming calls instead of sending outgoing calls. The user has to use his/her IPN at the fixed terminal, log on the home IPN server, and pass authentication before initiating any outgoing call.

However, through IPN service, the user can call an IPN number in reverse-charge mode or send short messages to the opposite end to request for connecting. The user can also view the simple Web page submitted at logon through the fixed terminal or browse toll-free websites provided by the IPN system.

Said 3 new protocols will be described in detail hereinafter.

1. ISP (IPN Server's Protocol)

Each IPN server has a certain number of home users and home HTTPex servers running HSP. The IPN server is in charge of authentication of user logon and periodic user detection. In addition, the IPN server also performs HTTPex connection establishment between the caller and the called. Through transferring information via the IPN server, IPN users can send short messages to each other.

The step for establishing a HTTPex connection between a calling IPN user and a called IPN user comprises:

(1) The caller logs on the home IPN server through the HTTPex client on any intelligent terminal that supports network access.

During logon, the user should input his/her IPN and password or E-mail address and password provided during registration. After successful logon, the connection between the IPN user and the IPN server will be kept through sending TCP ACK messages periodically (once every 5s or 10s) between the user and the server. The home IPN server will deems that the user is online only if the connection exists. In case the user doesn't send ACK message to the IPN server for several periodicities, the IPN server will deem that the users is offline; in this case, the user has to log on the IPN server again before he/she can use IPN service.

(2) The caller opens the call window on the client and input the called IPN or requests the IPN server to search for the called by E-mail address. If the caller chooses to search for the called IPN by the E-mail address, the searching process will be achieved through accessing a database that stores IPNs and E-mail addresses. The caller should send the call information to the home IPN server.

(3) The calling home IPN server parses the fields of the called IPN, and determines the IP address of the called home IPN server through searching in the database; or it translates the E-mail address to IPN, and performs the same processing.

(4) The calling home IPN server informs the called home IPN server.

(5) The called home IPN server determines whether the called is online. If the called is online, it informs the called. The informing message contains the caller's information, the IP address of the calling IPN server, and other necessary information.

(6) The called receives the call notice.

If the called accepts the call, he/she sends a response to his/her home IPN server to grant connection;

If the called doesn't accept the call, he/she returns a CONNECTION REJECTION message to the caller;

If the called doesn't respond for a long time, the calling home IPN server will return a CONNECTION REJECTED message to the caller.

(7) If the called grants connection, the caller and the called apply for HTTPex service ID from the calling home IPN server simultaneously.

(8) The calling home IPN server determines the HTTPex server for the current connection, the HTTPex service ID of the caller, and the HTTPex service ID of the called.

(9) The calling IPN server sends the two service IDs and the IP address of the HTTPex server to the caller and the called, respectively. Meanwhile, it sends caller ID and called ID information (including public network IP addresses used by the caller and the called for network access, HTTPex service IDs of the caller and the called, and connection establishment information) to the determined HTTPex servers.

(10) The caller and the called establish connections to the HTTPex servers respectively. The connections will be kept till either party hangs up or doesn't response for a long time; in this case, the connections will be disconnected by the HTTPex servers.

In this patent, above connections are called as HTTPex connections. After the connections are established, the upper layer applications will receive/send data packets through these HTTPex connections. The symbol of the connections is that the users have fixed source port numbers.

(11) After that, the HTTPex servers will exchange data between the two connections, equivalent to a connection between the upper layer applications of the caller and the called. The caller and the called can exchange data packets of upper layer applications through HTTPex protocol.

(12) When either of the two users wants to disconnect, he/she will send a request to the IPN server to cancel the HTTPex service ID; the IPN server will notify the opposite user and HTTPex server to cancel the connection.

(13) When the HTTPex server detects the connection is idle for a certain time, it deletes the connection automatically. At the same time, it will send the CONNECTION DELETED message to the home IPN servers of the users. In this case, the IPN servers will cancel the HTTPex server IDs of the two users. This is to prevent occupation of HTTPex service ID resource for a long time in case of sudden drop line and unpunctual notification.

The HTTPex client sets the IP address of the home IPN server, which is a legal IP address in the public network. When the user logs on the IPN server, the IP address of the IPN server may be substituted with a domain name.

Before the connection to the upper layer application of another user is established, the HTTPex user should establish a connection to the IPN server and the HTTPex server. Because the user described here is a user in a private network such as intranet or community network, the connection is implemented via a proxy server. Presently, there are two types of proxy servers. If the user sends a TCP SYN message to the IP address of the proxy server to establish a connection instead of establishing the connection to the Web server directly, such a proxy server is the first type; if the Web browser sends a TCP SYN message directly to the IP address of the Web server, such a proxy server is the second type. If a user accesses the network via a proxy server of the first type, the IP address and the port (default: 8080) of the proxy server should be set at the HTTPex client. If the user accesses the network via a proxy server of the second type, the IP address of the proxy server shall be taken as the default IP gateway of the client. In addition, the HTTPex client should set the destination IP address (i.e., VIP) and destination port (default: all) intercepted from the upper layer application.

2. The HTTPex protocol stipulates: when the user's upper layer application communicates with the opposite upper layer application via an HTTPex connection, the flow of the upper layer data packets should be:

(1) The IP address of the opposite upper layer application should be a VIP, and the address is the destination IP address intercepted by the HTTPex client from upper layer. All of the destination IP addresses that should be transferred to the message of the opposite upper layer application should be VIP addresses.

(2) The HTTPex client intercepts the upper layer application data packet and processes it as follows:

(i) Replacing the VIP destination address with the IP address of the HTTPex server while neglecting to replacing for data packet to other addresses;

(ii) The destination port of the upper layer application serving as the Destination Port Segment (DPS) in the data packet;

(iii) The source port of the upper layer application serving as the Source Port Segment (SPS) in the data packet;

(iv) Replacing the destination port of the data packet with the access port;

(v) Replacing the source port of the data packet with the HTTPex-connected source port.

Before the data packet is sent via the network access port, a PUSH command should be issued through HTTPex protocol to request the HTTPex server to receive and process subsequent data packets.

(3) The HTTPex client transfers the re-encapsulated data packet to the HTTPex server via the proxy server or the default gateway, i.e., the data packet after replacing operation is sent through the HTTPex connection.

(4) The HTTPex server transfers the data packet from the current receiving mailbox to the opposite sending mailbox.

(5) When detecting the data packet in the sending mailbox, the HTTPex server replaces the IP address and port of the data packet;

(i) Replacing the destination IP address of the data packet with the source IP address for network access of the current user (i.e., the IP address for accessing the HTTPex server);

(ii) Replacing the destination port of the data packet with the source port of the opposite user, i.e., the source port for accessing the HTTPex server, said source port is fixed during connection establishment;

(iii) Replacing the source port of the data packet with the HTTP port;

The content of the packet (including DPS and SPS) will not be changed.

(6) The HTTPex server receives the POP command from the client and then sends the data packet to the opposite user. All data packets of the caller and the called are sent and received with PUSH and POP command via the unique connection to the HTTPex server. The HTTPex server exchanges all of the data.

(7) The opposite HTTPex client parses the data packet obtained from the server into a message that can be used by the upper layer application, as follows;

i) extracting the DPS in the data packet and replacing it with the destination port of the data packet;

(ii) extracting the SPS in the data packet and replacing it with the source port of the data packet;

(iii) Replacing the source IP address in the data packet with the VIP address set by the upper layer application.

(8) The opposite HTTPex client transfers the processed message to the upper layer application.

(9) The upper layer applications of the caller and the called accomplish upper layer connection establishment and exchange of upper layer application data through exchanging data packets repeatedly with each other.

An IPN user may connect to a plurality of other users simultaneously. Similarly, a server supporting HTTPex protocol can provide service for a plurality of users simultaneously.

HTTP protocol supports concurrent connections. The user may open a plurality of browsing windows, and even different windows can display the same content; however, different browser windows have to use different TCP connections. From the viewpoint of the TCP field, different connections have different source ports.

A plurality of HTTPex connections may be used if only the upper layer application supports multiple connections. When the upper layer application supports a plurality of connections, a plurality of VIP addresses that are to be intercepted should be set at the HTTPex client, and then the user may instruct the upper layer application to connect those VIP addresses. The HTTPex client maps those VIP addresses to different HTTPex service IDs, each of which represents a connection to the HTTPex server, and each connection has its own source port.

The user's authority may be set on the IPN server to restrict the maximum number of service IDs that can be applied for by the user. Usually, a user can apply for only one service ID. The maximum number of service IDs that can by applied for by a server should be determined according to the capability of the server, in order to realize load equalizing effectively to avoid server overload.

The HTTPex service IDs are obtained from the calling home IPN server by the caller and the called after IPNs of the two parties are authenticated and the called confirms the call request of the caller.

The entire server cluster that supports HTTPex may be regarded as an IPN user. The IPN server knows the IP address and the capacity of every server in the server cluster; therefore, the IPN server may allocate the calls evenly to the servers in the server cluster. When an end user calls the server cluster via the IPN system and is authenticated successfully, a service ID should be applied for from the home IPN server of the server cluster instead of from the home IPN server of the end user. In this way, load equalizing and central billing in the entire server cluster can be achieved. When the server cluster provides a service, the corresponding HTTPex server will create billing information and send the billing information to the billing module of the calling IPN system via the IPN server.

The HTTPex server establishes receiving and sending mailboxes for the caller and the called and exchanges data packets between the mailboxes through HSP protocol. The HTTPex server detects whether there is any data packet in the receiving mailbox or sending mailbox periodically; in case there is a data packet in the receiving mailbox at either end, it will transfer the data packet immediately to the opposite sending mailbox.

The HTTPex server determines the querying interval in the user's mailbox according to the bandwidth specified by the user during the connection is established; for example, if the bandwidth is 1 Mbps, the number of data packets received/sent per second may be above 1,000; therefore, the HTTPex server should query in the sending/receiving mailbox more than 1,000 times per second.

The IPN server will check the condition of the users in the database at certain time interval. In case there is any variation, it will adjust automatically according to the database. After system installation, the system can operate automatically. If the system administrator wants to add or delete a user, he/she can modify the database instead of manipulating the IPN server or HTTPex server. The database file is stored like a script file, and its content can be view with a text editor to facilitate manual troubleshooting in case of workflow failure. Owing that each IPN server only supports a limited number of users, the maximum length of the database file is also limited.

After the connection is established between the two parties, the two users should apply for HTTPex service IDs from the calling IPN server. In order to obtain the IDs, the user should accomplish the interactive process to the IPN server. The interactive process is as follows with reference to DHCP:

1. The HTTPex client sends an ID-DISCOVER packet to the IPN server;

2. The IPN server responds with an ID-OFFER packet to the user, said packet contains the IP address of the HTTPex server, user ID, and other configuration information;

3. The user sends an ID-REQUEST data packet to the IPN server to confirm the allocated ID and other parameters;

4. The IPN server responds with an ID-ACK data packet to the user to confirm the allocation;

DHCP protocol stipulates that each data packet should be a UDP message of 576-byte length or less. Therefore, the application for service ID from the HTTPex client shall comply with this requirement.

DHCP protocol employs a LEASE concept, which refers to the valid period of the IP address afforded to the DHCP client by the DHCP server. The IPN client should also request for LEASE from the IPN server periodically. In case the HTTPex client doesn't request for LEASE for a certain time period, the IPN server will request the HTTPex server to delete the corresponding service ID to disconnect the HTTPex connection.

A service ID maybe digits of one or two bytes, and different HTTPex servers may use the same IDs. Employing IDs may help to reduce system overhead and enhance network transmission efficiency. However, those IDs are only for IPN servers and HTTPex servers; either party needn't to know the ID of the opposite user.

The function and role of HTTPex in the present invention are as follows:

As an application program, HTTPex runs on the user's intelligent terminal (usually a computer). It can encapsulate data packets of various upper layer applications into data packets with Web access port information and transfer the encapsulated data packet to the HTTPex server. On the contrary, it parses the data packets received from HTTPex server into data packets of upper layer applications and forwards them to the upper layer applications to process.

The HTTPex protocol defines a new “upper layer port” field in the carried data. The field is 4-byte length and contains source port number and destination port number. The source port segment (SPS) occupies two bytes; while the destination port segment (DPS) occupies the rest two bytes. When an upper layer application uses an HTTPex connection to send/receive messages, the SPS and DPS in those messages shall be replaced; therefore, the SPS and DPS of the upper layer application should be stored to a new field.

HTTPex protocol can converge various upper layer applications to the Web access port. Any user with web browsing premise can use any PC-to-PC upper layer application. In addition, if the server cluster supports HTTPex protocol (serves as an HTTPex client), the HTTPex server can perform billing and charging for the server cluster according to the data flow provided by the server cluster. The HTTPex server can also allocate evenly the data flow to the servers in the server cluster, i.e., it can provide load equalizing function for the server cluster in a software manner.

HTTPex protocol employs the same rule as HTTP protocol and is compatible with HTTP protocol. The main difference between them is: HTTPex protocol adds PUSH and POP requests on existing commands of HTTP protocol; whereas the common requests of HTTP protocol include only GET and POST, wherein:

The GET request is designed to get WebPages. It is followed by webpage location as the parameter. When accepting the request, the server returns the requested page. Besides webpage location, the command can also be followed by protocol version information, such as HTTP/1.0, in order to provide more information to the server.

The POST request is designed to request the server to receive information. Besides the parameters after the POST command, the browser also sends data to the server continuously. Usually, POST method has intimate relation with CGI programs in the server, and the server will launch CGI programs to process the data transferred by the client.

In addition, HTTP 1.1 also defines a plurality of access methods and some new commands, such as PUT and DELETE, etc. The PUT request is designed to place the web pages at correct positions; whereas the DELETE request is designed to delete relevant files. However, said commands are nearly not used presently, and most Web server software doesn't implement them. In case the server doesn't support the request method sent by the client, it will return an ERROR message to the client and disconnect the connection immediately.

The PUSH and POP requests in HTTPex protocol achieve the following functions:

(1) HTTPex PUSH

PUSH operates in a similar way as HTTP1.0 POST; the difference between them is: POST is processed by CGI program, whereas PUSH requests the HTTPex server to process according to HSP protocol.

The intent of the present patent application is not to set sedulously a PUSH command that never exists in traditional HTTP protocol, Because Web server employs virtual domain concept and can send data packets to specific virtual domains with POST command. The efficacy of POST method is similar to that of PUSH method. However, this method requires more consideration on configuration of virtual domain.

PUSH command is introduced in this patent application for description object.

HTTPex PUSH command requests the server to receive the information from the client. It may be followed by the following parameters:

a. HTTPex Service ID of client;

b. Client ID information;

Client ID is similar to E-tag and Cookie and is designed to help the HTTPex server to identify the user. For security, HTTPex server will update the information automatically at a certain time interval.

After sending the PUSH request and receiving the response from HTTPex server, HTTPex client will send data packets to the HTTPex server for processing. When receiving a PUSH request, process on the HTTPex server comprises the following steps:

a. Responding to the PUSH request;

b. Placing the subsequent data packets received from the client to the receiving mailbox for the client;

c. When the server queries in the receiving mailbox, the data packets being transferred to the sending mailbox for the opposite user;

d. When a data packet enters the sending mailbox for the opposite user, the IP address and port number being replaced as follows:

(i) The destination IP address is replaced with the IP address used by the opposite user for network access;

(ii) The destination port number is replaced with the source port number used by the opposite user for network access (for establishing HTTPex connection);

(iii) The source port number is replaced with HTTP port number (80);

After replacing operation, the data packet may be sent to the opposite user through the network.

e. When receiving the POP command sent by the opposite user, the HTTPex server responds to the user, and sends the data packets to the opposite user via the opposite connection.

The data packets sent after PUSH request may be data packets of various upper layer applications.

A VIP address should be set on the HTTPex client to enable the HTTPex application to intercept upper layer data packets according to it. All data packets sent by any upper layer application to the VIP address will be intercepted by the HTTPex application. After the data packets are intercepted, the IP address and port numbers in them will be replaced to regenerate data packets with Web access port information. After that, the data packets will be sent to the HTTPex server via the web access port.

HTTPex clients support “HTTPex-connection-oriented firewall”. That is to say, the users may configure the upper layer applications for which the data packets will be intercepted according to the port numbers. If the destination port number of a data packet sent by the user is beyond those port numbers, or the source port number of a data packet received from the opposite user is beyond those port numbers, an alarm will be sent to the user and the data packet should be processed correspondingly.

It should be noted that when the opposite client serves as the client and the source port number is allocated randomly within a certain arrange (in Windows 98, the port numbers in a range will be allocated in an increment manner), more factors should be considered in judgment of opposite source port numbers.

“HTTPex-connection-oriented firewall” function is disabled by default, i.e., in default cases, HTTPex applications intercept upper layer data packets according to the following criteria: the upper layer data packets will be intercepted if only the destination IP addresses of the data packets are VIP addresses and be transmitted via HTTPex connection, and the specific port numbers will not be judged.

When a data packet is intercepted from the upper layer application port and encapsulated into the data packet with Web access port, the upper layer source/destination port numbers are stored into the new “upper layer port” field. The field comprises 4 bytes, including SPS and DPS, each of which occupies 2 bytes.

(2) HTTPex POP

It is similar to HTTP1.0 GET. The difference between them is: GET requests to obtain web pages from the Web server, whereas POP requests to receive data packets from the sending mailbox on the HTTPex server.

The intent of the present patent application is not to set sedulously a POP command that is not seen in common HTTP protocol, because Web servers employ virtual domain concept and can obtain data packets from specific virtual domains with GET command. The efficacy of Get is similar to that of POP; however, it requires more consideration on configuration of virtual domain.

POP command is introduced in the present patent application for description object.

POP command may be followed with the following parameters:

a. HTTPex service ID of the client;

b. Client ID information;

The HTTPex server processes the POP request as follows:

a. Responding to the user for the POP request;

b. Modifying user ID information;

c. Querying in the sending mailbox. If there is any data packet in the sending mailbox, transfers the data packet to the user.

Returns a “mailbox empty” message to the user if there is no data packet in the sending mailbox;

When receiving a data packet from the bottom layer, an HTTPex application performs as follows:

a. Identifying source/destination IP addresses and source/destination ports to determine whether the data packet is sent through an established HTTPex connection from the HTTPex server. If yes, intercepting the data packet and processing it further; if not, forwarding the data packet to the upper layer application or discarding the data packet as required;

b. Processing the data packet further, i.e., recovering the “upper layer port” field (4 bytes) in the data packet with the source port and destination port, and then deleting the field;

c. Identifying the SPS according to the “HTTPex-connection-oriented firewall” set by the user; if the SPS is not within the range set by the user, sending an alarm to the user;

d. Replacing the source IP address of the data packet with the VIP address;

e. Now, the data packet being a standard data packet for the upper layer application and being transferred to the upper layer application.

In this way, seamless communication between upper layer applications on HTTPex clients can be achieved.

Besides PUSH and POP, HTTPex protocol also provides SAVE, SEEK, and other commands.

The commands support specific conversions to data packets and storing the data packets to a Storage Area Network (SAN).

HTTPex clients run in Windows OS.

In Windows 9x, applications and Win32API are unable to access bottom network layers. To support bottom layer manipulation, corresponding VxDs (Virtual Device Drivers) should be implemented, which will serve as interfaces between NIC (Network Interface Card) and upper layer Win32 applications. Though Win32 applications at Ring3 layer are unable to access substrate hardware resources directly, they may control NDIS to communication with the NIC through calling VxDs.

To enhance compatibility of OS, the VxDs invoked by Win32 applications don't communicate directly with the NIC; instead, they communicate with the NIC through an interface abstraction layer NDIS3.10 between them and network hardware. The main role of NDIS is to release software from details of NIC and enable the drivers to communicate with any NIC. Of cause, the premise is that the NIC has to be compatible with NDIS. That approach helps to simplify VxD design and shorten development cycle.

When trying to invoke a VxD, an application queries for the DDB (Device Descriptor Block) of the VxD via the VMM (Virtual Machine Manager) to obtain the main entry point of the VxD. The VMM utilizes the main entry point to inform the VxD of the status of VM and Windows; then, the VxD responds to the events through corresponding operations. Win32API provides interface functions “CreateFile( )/CloseHandle( )” to load/unload the VxD dynamically.

With the VxD, Ring3 applications can intercept MAC data packets directly. In this way, HTTPex applications may be developed without the help of TCP/IP processing steps embedded in Windows. The core of the HTTPex application is a VxD.

The key of an HTTPex client is: its interface to upper layer applications should be complete. When it receives data packets, it should transfer the processed data packets to upper layer applications such as VOIP and Netmeeting. When it sends data packets, it should receive data packets from upper layer applications and transfer them to the bottom layer after processing.

The implementation of data packet exchanging function on an HTTPex server is different to that on an HTTPex client. This is because that HTTPex function is similar to a router, both of which achieve data exchange. However, the data exchange function of HTTPex is implemented on the application layer, whereas the data exchange (forwarding) function of router is implemented on the IP layer.

In hardware, an HTTPex server may be a common computer running Windows, UNIX or Linux OS and the upper layer application. An HTTPex server may also be implemented with software and hardware of a router, such as CPX8216 CPCI hardware platform with an Ethernet adapter. In this case, the OS may be VxWorks.

The advantage of implementing HTTPex server with an embedded system is: enhanced hardware integrity and stability, reduced software size, enhanced security, and free of security hole of any common OS. The HTTPex server may be implemented on router VOS and VRP (Versatile Routing Platform).

3. The function and role of HSP (HTTPex Server's Protocol) in the data network system are: the HTTPex server running it establishes the connection to the user according to the user information from the IPN server and exchanges data packets between the users, i.e., the HTTPex Server sends the data packets in the receiving mailbox for either user to the sending mailbox for the other user according to the user's HTTPex service ID and transfers the data packets in the receiving mailbox for the other user to the sending mailbox of the current user. The capacity of receiving/sending mailboxes and the querying times per second should be determined by server memory, server processing capability, user level and actual conditions of the network.

HSP exchanges the data packets in the receiving/sending mailboxes for the two users according to the HTTPex service ID. The data exchange is performed between data area within the HTTPex server and is invisible to external world. During that process, only the IP addresses and ports are replaced and no other processing.

An efficient HSP server processing method is: when the HSP receives a data packet, a bell for the receiving mailbox is set to inform the CPU that a data packet arrives at the receiving mailbox. In this way, the CPU needn't to query in the receiving box. That approach is similar to the interrupt mechanism in computers.

With HSP protocol, various upper layer applications between intranet users, IPv6 network users or other new network users and traditional public network users can be implemented. A client may run an HTTPex application to establish a connection to any client running HTTPex to achieve seamless communication between various upper layer applications.

During exchanging user data, HSP can record the traffic volume and connection duration information, which, along with IPNs and HTTPex service IDs of the caller and called user, is transferred to the billing module for billing and charging. The billing function is achieved with the billing module. The key billing information includes: IPNs of the caller and the called, number of input bytes, number of output bytes, number of input packets, number of output packets and the duration of current session.

Similarly, HTTPex server may also perform billing for a website by the traffic.

In case the server cluster of a website supports HTTPex protocol and serves as the called, the billing for the website by traffic may be achieved. The billing approach is different to the traditional billing approach that is performed by total traffic volume and bandwidth of user ports, and it is the most appropriate billing method.

In conclusion, the 3 protocols are described in detail.

From above description we can know, because the data network system in the present invention is implemented through adding HTTPex servers and IPN servers as well as 3 new protocols on the traditional network and it designates a home IPN server for each user, the users establish connections to other users and HTTPex servers via their home IPN servers and then exchange data packets through the HTTPex servers, thus direct communication between upper layer applications of network users may be implemented, not confined by user type. In the future, when 3 G cell phones are widely used, the method and system of the present invention will also support direct image exchange between computers and 3 G cell phones.

### Industrial Applicability

Because the data network system according to the present invention is implemented through adding HTTPex servers and IPN servers on the traditional network and it designates a home IPN server for each user, the users establish connections to other users and HTTPex servers via their home IPN servers and then exchange data packets through the HTTPex servers, thus direct communication between upper layer applications of network users may be implemented, not confined by user type.

It is obvious that the present invention has the following advantages:

(1) The system can implement direct communication between upper layer applications of network users;

(2) The system is superimposed on the traditional network; therefore, it is unnecessary to modify the traditional network, instead, only corresponding servers should be deployed on the network and client software should be installed on the users' computers. Thus a uniform interconnected network application platform may be implemented;

(3) It delivers load equalizing function for the servers as well as billing and charging services for content providers.

The present invention is described in detail above with reference to the embodiments and the drawings. It should be noted that the embodiments are only for illustration object and should not be deemed as constitute any limitation to the present invention. Any skilled in the art can make various modifications to the present invention without creative labor and escaping the spirit and scope of the present invention. Therefore, any such modification shall be deemed to fall in the scope of the claims of the present invention.

1. A method of exchanging data between data network users, wherein comprises: registering an IP number (IPN) and determining a home IPN server for each user; the IPNs of the users are stored in the corresponding home IPN servers; the connecting step between the users via IPNs and IPN servers comprises the following steps:
A. The caller logging on the home IPN server;
B. The caller searching for the called home IPN server according to its home IPN server and the called IPN;
C. The called home IPN server determining whether the called is online; if yes, it informing the called of the calling IPN and IP address of the calling home IPN server, otherwise ending the connection;
D. If the called doesn't give any response, the calling home IPN server returning a CONNECTION REJECTED message to the caller, otherwise going to the next step;
E. If the called gives a response to accept the call, the called home IPN server returning a CONNECTION GRANTED message to the caller; otherwise the called home IPN server returning a RECEPTION REJECTED message to the caller and ending the connection;
F. After the called confirms to connect, the caller and the called applying for HTTPex (Hypertext Transfer Protocol and its Extensive part) service IDs and the HTTPex servers for the current call connection from the calling home IPN server simultaneously;
G. The calling home IPN server sending the determined calling HTTPex service ID and called HTTPex service ID to the caller and the called respectively; at the same time, it also sending the caller ID and the called ID to determined HTTPex servers;
H. The caller and the called establishing connections to the HTTPex servers respectively and carrying out data exchange via the HTTPex servers;
I. Disconnecting the connections to the HTTPex servers to end the current call connection.

2. A method of exchanging data between data network users according to claim 1, wherein the caller logging on his/her home IPN server with his/her IPN and password according to step A further comprises the following steps:
1) the caller inputting the IPN and password via the terminal;
2) the home IPN server authenticating the inputted IPN and password;
3) after successful authentication, the connection between the caller's terminal and the home IPN server being kept.

3. A method of exchanging data between data network users according to claim 1, wherein the caller logging on his/her home IPN server with his/her E-mail address and password according to step A further comprises the following steps:
1) the caller inputting the E-mail address and password via the terminal;
2) the home IPN server authenticating the inputted E-mail address and password;
3) after successful authentication, the connection between the caller's terminal and the home IPN server being kept.

4. A method of exchanging data between data network users according to claim 1, 2 or 3, wherein the caller searching for the called home IPN server according to its home IPN server and the called IPN according to said step B further comprises the following steps:
1) the caller inputting the called IPN;
2) the calling home IPN server parsing the inputted called IPN and searching in the database to obtain the IP address of the called home IPN server;
3) the calling home IPN server informing the called home IPN server according to the IP address searched to establish the connection between said two servers.

5. A method of exchanging data between data network users according to claim 1, 2 or 3, wherein the caller searching for the called home IPN server according to its home IPN server and the called IPN according to said step B further comprises the following steps:
1) the caller inputting the E-mail address of the called;
2) searching in the database according to said E-mail address to obtain the called IPN;
3) the calling home IPN server parsing said inputted called IPN and searching in the database to obtain the IP address of the called home IPN server;
4) the calling home IPN server informing the called home IPN server according to the IP address searched to establish the connection between said two servers.

6. A method of exchanging data between data network users according to claim 1, 2 or 3, wherein the caller and the called establishing connections to the HTTPex servers to carry out data exchange according to step H comprises exchanging upper layer data packets; the step of transmission of the upper layer data packet from the current user to the opposite user comprises the following steps:
1) The caller or the called encapsulating the upper layer data packet and then sending them to the HTTPex server;
2) The HTTPex server transferring the data packet from the current receiving mailbox to the opposite sending mailbox;
3) When finding the data packet in the opposite sending mailbox, the HTTPex server replacing the IP address and port in the data packet;
4) When receiving a “POP” command from the opposite user, the HTTPex server sending the modified data packet to the opposite user;
5) The opposite user parsing the data packet and forwarding them to the upper layer application.

7. A method of exchanging data according to claim 6, wherein the caller or the called encapsulating the upper layer data packet and then sending them to the HTTPex server according to step 1) further comprises the following steps:
a. The upper layer application of the caller or the called connecting the opposite virtual IP (VIP);
b. HTTPex client side of the user intercepting the upper layer application data packet and processing them as follows:
(i) Replacing the opposite VIP destination address with the IP address of the HTTPex server while neglecting to replacing for data packet to other addresses;
(ii) The destination port of the upper layer application serving as the Destination Port Segment (DPS) in the data packet;
(iii) The source port of the upper layer application serving as the Source Port Segment (SPS) in the data packet;
(iv) Replacing the destination port of the data packet with the current access port or the proxy server's access port;
(v) Replacing the source port of the data packet with the HTTPex-connected source port;
c. Adding a PUSH command to the processed data packet, encapsulating the data packet, and then sending the encapsulated data packet to the HTTPex server via the proxy server or the gateway.

8. A method of exchanging data according to claim 7, wherein said PUSH command is designed to request the HTTPex server to receive the information from the user, said information comprises:
i) the user's HTTPex service ID;
(ii) user ID

9. A method of exchanging data according to claim 6, wherein said POP command is designed to request the HTTPex server to receive data packets from the sending mailbox, said information comprises:
(i) the user's HTTPex service ID;
(ii) user ID

10. A method of exchanging data according to claim 6, wherein the HTTPex server checking whether there is new data packet in the opposite sending mailbox according to step 3) is performed by the server's central processing unit in polling mode.

11. A method of exchanging data according to claim 6, wherein the HTTPex server checking whether there is new data packet in the opposite sending mailbox according to step 3) is performed by a mailbox bell; i.e., a mailbox bell is set first, when a new data packet arrives at said mailbox, said mailbox bell will inform the server's central processing unit automatically.

12. A method of exchanging data according to claim 6, wherein in said step 3), if finding a data packet in the opposite sending mailbox, the HTTPex server replacing the IP address and port of the data packet comprises the following steps:
Wherein the HTTPex server replacing the IP address and port in the data packet when finding the data packet in the opposite sending mailbox according to step 3) further comprises the following steps:
(i) Replacing the destination IP address of the data packet (i.e., IP address of the HTTPex server) with the source IP address for access of the current user (i.e., the IP address for accessing the HTTPex server);
(ii) Replacing the destination port of the data packet with the source port of the opposite user;
(iii) Replacing the source port of the data packet with the HTTP port.

13. A method of exchanging data according to claim 6, wherein the opposite user parsing the data packet into messages of upper layer application according to step 5) further comprises the following steps:
i) extracting the DPS in the data packet and replacing it with the destination port of the data packet;
(ii) extracting the SPS in the data packet and replacing it with the source port of the data packet;
(iii) Replacing the source IP address in the data packet with the VIP address set by the upper layer application.

14. A data network service system implementing the method of exchanging data according to claim 1, comprising:
User terminals;
Background system, which is designed to monitor network operation conditions, preset user accounts manually or automatically, modify user properties manually, and perform troubleshooting in case of network failure;
Authentication database, which is designed to store various user identity information;
A connection network, which is used to connect said devices and support communication between them; said system also comprises:
IPN servers, which are designed to achieve user's logon and user's HTTPex service ID application;
HTTPex servers, which are designed to support data exchange between users.

15. A data network service system according to claim 14, wherein also comprising a registration server, which is designed to perform registration for new users.

16. A data network service system according to claim 14 or 15, wherein also comprising a billing module, which is designed to perform real-time billing for users.

17. A data network service system according to claim 14 or 15, wherein also comprising an application layer gateway, which is designed to connect to various networks for users through HTTPex access, so as to provide various network services for users.
